(19) United States
(12) Patent Application Publication
(10) Pub. No.: US 2002/0143613 A1
(43) Pub. Date: Oct. 3, 2002

(54) Fast method for renewal and associated recommendations for market basket items

(76) Inventors: Se June Hong, Yorktown Heights, NY (US); Ramesh Natarajan, Pleasantville, NY (US); Ilana Belitskaya, South San Francisco, CA (US)

Correspondence Address: McGuireWoods, LLP, Suite 1800, 1750 Tysons Boulevard, Tysons Corner, McLean, VA, 22102-3915, US

(21) Appl. No.: 09/773,809

(22) Filed: Feb. 5, 2001

(51) Int. Cl. G06F 17/60

(52) U.S. Cl. 705/14

(57) ABSTRACT

When a customer is in the process of filling a market basket for purchase on an Internet commerce site, a method makes prioritized recommendation of items so as to maximize the likelihood that the customer will add to the basket those items that are in the list with higher priorities. The method separately considers in turn preferences due to a current set of items in the market basket and also preferences due to a new choice independent of what is in the market basket. In this way, the method recognizes that not all items in the market basket are selected because of their affinity with some other item already in the basket. The two preferences are estimated separately from training data and combined in proper proportions to obtain an overall preference for item not yet in the market basket.

### DESCRIPTION

### BACKGROUND OF THE INVENTION

1. Field of the Invention

The present invention generally relates to a computer method and system for placing orders for products over a computer network, such as the Internet, and more particularly, to a way to more effectively and efficiently determine a customer's preferences while the customer's choices are in progress in order to make recommendations of other items the customer might be interested in purchasing. More generally, further recommendations while a customer is making choices applies to any such situation, e.g., a customer makes a series of Internet surfing choices and new sites are dynamically recommended and displayed (by icons). Aside from virtual shopping carts, this can also apply to the real shopping cart with displays. As a customer fills the cart, the display points to the next items the customer is likely to add to the cart.

2. Background Description

Shopping on the World Wide Web (WWW or simply the Web) portion of the Internet has become ubiquitous in our society. A typical Web site offering products for purchase employs what is referred to as a “market basket”, a sort of virtual shopping cart without wheels. The customer selects items to add to his or her market basket, and when he or she completes their shopping, a “check out” button is selected to process the items then in the market basket.

A market strategy has developed which involves monitoring the items in the customer's market basket and, taking other factors into account including possibly the customer's past buying habits and similar choices made by other customers, making recommendations to the customer of other items he or she might be interested in purchasing. In the past decade, recommendations to a customer who has items in a market basket have been made using so called associative rules mined from the market basket data, or by several other means described, for example, in P. Resnick, N. Iacovou, M. Suchak, P. Berstrom and J. Riedl, “Grouplens: An open architecture for collaborative filtering of netnews”, Proceedings of the ACM 1994 Conference on Computer Supported Cooperative Work, pp. 175-186, ACM, New York (1994), J. Breese, D. Heckermnan, and C. Kadie, “Empirical analysis of predictive algorithms for collaborative filtering”, Proceedings of Fourteenth Conference on Uncertainty in Artificial Intelligence, Morgan Kaufmnan, Madison, Wisc. (1998), and others. The associative rules cannot be tailored to all possible partial market baskets. All the prior art in so called collaborative filtering technique require a substantial amount of computation.

### SUMMARY OF THE INVENTION

It is therefore an object of the present invention to provide a more effective and efficient process for recommending items to a customer for their market basket in an e-commerce site.

According to the invention, a new method is provided which is based on a novel theory that “not all items in the basket are selected because of their affinity with some other item already in the basket.” The method uniquely determines two separate components of item choice preferences: Preference by association with existing items in the basket in progress or independently exercised purchases. The former is the usual preference considered by all prior art methods. The latter is the renewal buying not considered by the prior art. In the present invention, these two preferences are separately estimated from the training data and combined in proper proportions to obtain the overall preference for each item not yet in the basket. The recommendations are presented in the form of ranking from which some subset of items at the top will be presented to the customer. The ranking is obtained from computed probabilities for each item that is not in the current basket, given the partial basket in progress. The method disclosed here is not restricted to purchasing of items. It can also be used for recommending new web-sites to someone browsing the Internet.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a table showing an array of binary data which represents items in market baskets; and

FIG. 2 is a flow diagram showing the logic of the computer implemented process according to the invention.

### DETAILED DESCRIPTION OF A PREFERRED EMBODIMENT OF THE INVENTION

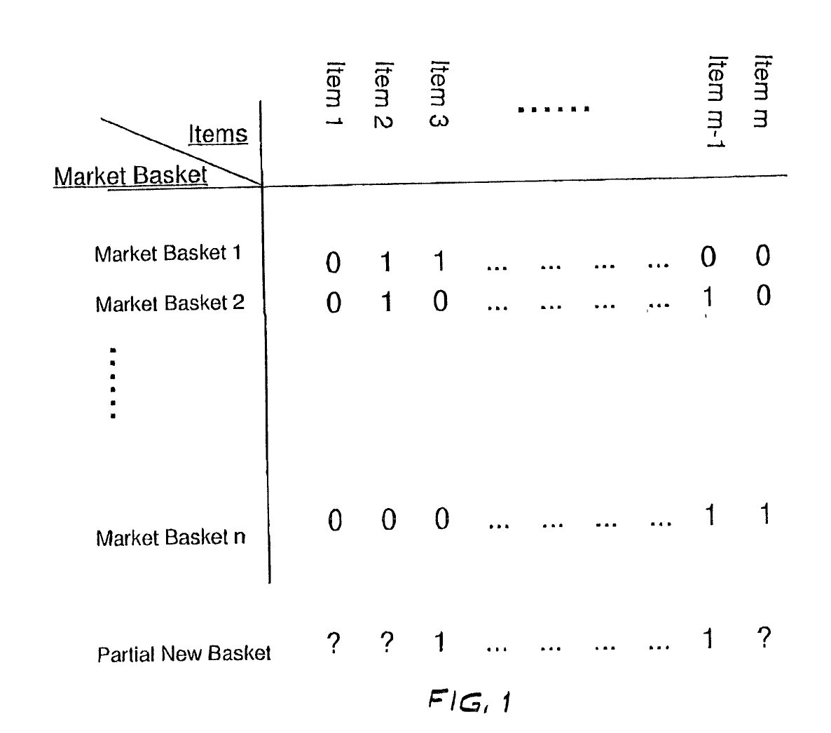

Referring now to the drawings, and more particularly to FIG. 1, there is shown a table which illustrates a binary array which represents items in market baskets. In this table, each row is a basket and each column represents an item. A binary value 1 in row i and column j signifies that the basket i contained item j and value 0 for the absence of the item. We shall denote such market basket data array as M, comprised of n baskets (rows) and m items (columns).

The current partial basket is denoted as B, the content items of which is denoted as i₁, i₂, . . . i_{b}, where the number of items in the basket, b, can be 0 if the basket is just beginning. Such case will be called a null basket, and the method to determine the preferences for the null basket will be separately described later.

The probability of a customer buying item j given the partial basket B is P(j|B). The key concept is to separately consider the probability components: one due to associative buying, and the other due to an independent, or renewal choice.

$$\begin{matrix}P ( j \vert B ) = P ( j , asso \vert B ) + P ( j , renewal \vert B ) \\ = P ( j \vert asso , B ) P ( asso \vert B ) + P ( j \vert renewal , B ) P ( renewal \vert B ) ,\end{matrix} \qquad ( 1 )$$

for all j not in B where, since one buys associatively or independently,

P(asso|B)=1−P(renewal|B) (2)

And in the case of renewal buy, the basket content is immaterial except for those items already in the partial basket B, and hence

$$\begin{matrix}P ( j \vert renewal , B ) = P ( j \vert renewal ) = P ( j , renewal ) / P ( renewal ) \\ = P ( renewal \vert j ) P ( j ) / P ( renewal ) ,\end{matrix} \qquad ( 3 )$$

where P(j) is the probability of item j being bought.

Now we make a simple but reasonable assumption about the purchase behavior we name “single item influence”. That is, whether the next buy is renewal or associative, it is determined as an aggregate of such tendency by the items in the current basket, singly. In other words, an associative next buy would be the result of its association to some one item in the basket and not because more than one item was needed for the association. We, likewise, assume each single item exerts its own tendency to non-associative, i.e., renewal, buying. These assumptions are reasonable and allow an efficient computation.

We make further simplifying assumptions about the purchasing behavior regarding the aggregation of the single item influence. In the case of renewal, we reasonably assume that the least renewal tendency among all the basket items dictate the final renewal. So, for aggregating the renewal probabilities,

P(renewal|B)=minₖP(renewal|iₖ), for k=1, 2, . . . , b, (4)

which will be estimated from the data in a manner described below. And in the case of associated buying, we reasonably assume that maximum preference to associatively select an item j among each item in the partial basket B determines the overall preference for the item j. That is, in pre-normalized form,

P′(j|asso,B=maxₖP(j|asso,iₖ) for k=1, 2, . . . , b. (5)

This quantity is set to zero for all items in the future partial basket for which recommendations are made. After that, they are normalized for probability, as

$$P ( j \vert asso , B ) = \frac{{P}^{′} ( j \vert asso , B )}{{\sum }_{j} {P}^{′} ( j \vert asso , B )} for all items j . \qquad ( 6 )$$

Now, the probability, P(j|asso, iₖ), of equation (5) is equivalent to (using i for iₖ)

$$\begin{matrix}P ( j \vert asso , i ) = \frac{P ( j , i , asso )}{P ( i , asso )} = \frac{- P ( j , i ) P ( asso \vert j , i )}{P ( i ) P ( asso \vert i )} \\ = \{ \frac{P ( j , i )}{P ( i )} \} \frac{\{ 1 - P ( renewal \vert j , i ) \}}{\{ 1 - P ( renewal \vert i ) \}} \\ = \frac{P ( j \vert i ) \{ 1 - P ( renewal \vert j , i ) \}}{\{ 1 - P ( renewal \vert i ) \}}\end{matrix} \qquad ( 7 )$$

When the partial basket in progress is empty, i.e., the null basket at the start, a customer is at precisely the “renewal” point. Therefore, for null basket B=null, equation (1) is specialized by use of equation (3).

P(j|null)=P(j|renewal) (8)

Now we describe sub methods to estimate P(j), P(renewal), P(renewal|j,i}, and P(j|i), etc. of the above equations from the data.

P(j) estimation: precomputed and stored in length m vector.

Let the column sums of M be n₁, n₂, . . . , nₖ, . . . , nₘ. The probability of item j being bought is then as

$$P ( j ) = \frac{{n}_{j}}{{\sum }_{k} {n}_{k}} \qquad \text{(9A)}$$

or optionally with a Laplace correction for small statistics as

$$P ( j ) = \frac{{n}_{j} + 1}{{\sum }_{k} {n}_{k} + 1} \qquad \text{(9B)}$$

P(renewal) estimation.

Let the number of singleton baskets of item j be nⱼ′. This quantity is underestimated by the proportion of all singleton baskets to the total items purchased in the training data. The reason is that every time only one item was bought, it is certainly a case of renewal. The renewal probability is then

$$P ( renewal ) = \frac{{\sum }_{j} {n}_{j}^{′}}{{\sum }_{j} {n}_{j}} \qquad ( 10 )$$

P(renewal|i) estimation: precomputed and stored in a length m vector.

Given the item i is bought, the estimate of renewal probability is done in two stages. Let the total number of baskets where the item i is the singleton basket content be nᵢ′, then for

$$\frac{{n}_{i}^{′}}{{n}_{i}}$$

of the time, it is certain case of renewal,

and for the remaining proportions, i.e., for

$$1 - ( \frac{{n}_{i}^{′}}{{n}_{i}} )$$

of the time, there are other items bought along with the item i, but some portion of it, which we estimate to be P(renewal), would be also renewal case. Therefore, the estimate is

$$P ( renewal \vert i ) = ( \frac{{n}_{i}^{′}}{{n}_{i}} ) + P ( renewal ) \times ( 1 - ( \frac{{n}_{i}^{′}}{{n}_{i}} ) ) \qquad ( 11 )$$

P(j|renewal) computation: precomputed and stored in a length m vector.

P(j|renewal) is computed using the above estimated quantities and stored according to equation (3).

P(j|i) estimation:

Let the subset of M that has 1 in i-th column be Mᵢ, i.e., those rows that have item i in the basket. The j-th column sum of Mᵢ, denoted as nⱼᵢ, represent the number of times j was bought along with i. Therefore,

$$P ( j \vert i ) = \frac{{n}_{ji}}{{\sum }_{k} {n}_{ki}} , and we fix P ( i \vert i ) to be 0 \qquad ( 12 )$$

P(renewal|j,i) estimation:

From sub matrix Mᵢ above, the number of rows whose sum is exactly 2 represents a certain case of renewal. Let nⱼᵢ′ denote the number of rows whose row sum in Mᵢ is exactly 2 and contains item j. The certain renewal proportion is nⱼᵢ′/nⱼᵢ. In the remaining cases, we estimate that the renewal is the same as P(renewal). So,

$$P ( renewal \vert j , i ) = ( \frac{{n}_{ji}^{′}}{{n}_{ji}} ) + P ( renewal ) \times ( 1 - ( \frac{{n}_{ji}^{′}}{{n}_{ji}} ) ) \qquad ( 13 )$$

P(j|asso, i) computation: precomputed and stored in an m by m array or an equivalent sparce matrix representation.

Using the estimate above, P(j|asso, i) of equation (7) is computed and stored.

P(j|asso, B) computation:

First, we obtain P′(j|asso, B) of equation (5) using equation (7) and the quantities developed above. Since the items already in the partial basket are not bought again, we fix it to zero whenever j is in B. Now, the normalized probability of j being purchased associated with the partial basket is

$$P ( j \vert asso , B ) = \frac{{P}^{′} ( j \vert asso , B )}{{\sum }_{k} {P}^{′} ( k \vert asso , B )} \qquad ( 14 )$$

P(j|renewal, B)=P(j|renewal) normalization for partial basket B:

The P(j|renewal, B)=P(j|renewal) of equation (3) is now fixed for those j's that are already in the partial basket B to be zero, and normalized by dividing them by the sum over all j's before the final goal P(j|B) is computed from equation (1) using the partial quantities developed herewith.

The final recommendation for items based on the current partial basket in progress is then in descending P(j|B) ranking. The probability itself can be used for a direct gain maximization if the profit amount for each item is known. It that case, one would multiply the probabilities with the corresponding profit amount before ranking is made. More specifically, when each item's profit amount, $ⱼ, is known, one computes P(j|B)$ⱼ and produces the ranking for recommendations based on this quantity.

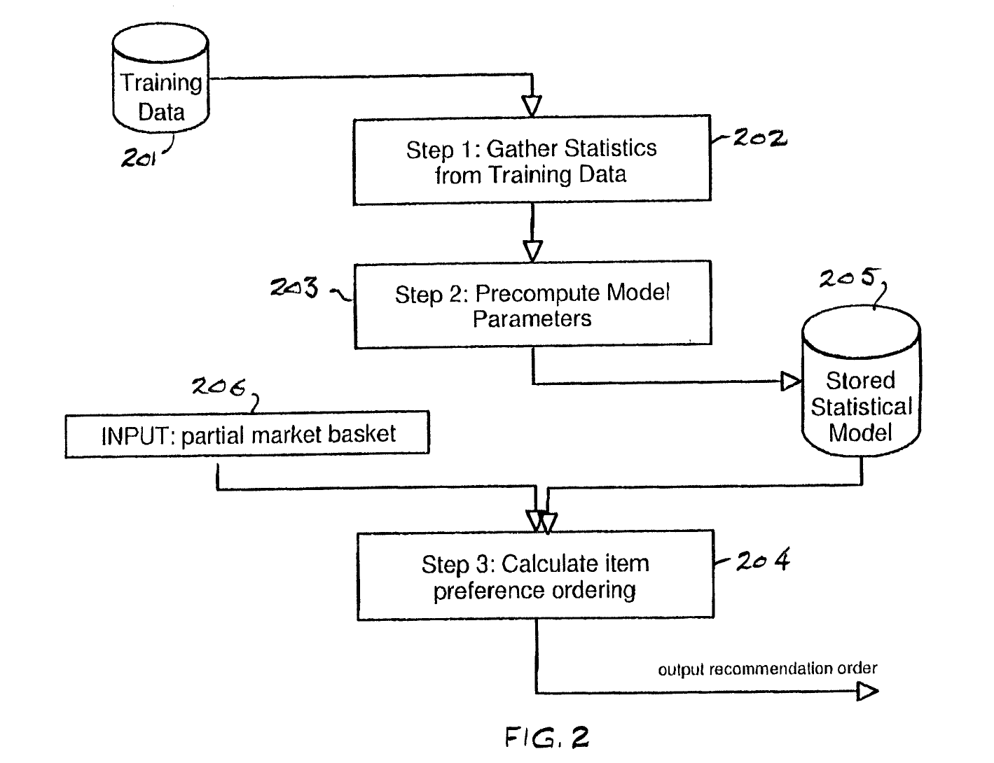

The process is illustrated in FIG. 2. The method comprises three steps. The first two steps use the market basket information in the training data base 201. Specifically, in the first step 202, certain statistics are collected which are then used in the second step 203 to precompute certain quantities. The third step 204 uses the precomputed quantities, in the stored statistical model 205, and the partial market basket information 206 in an online manner to produce a preference ranking for the remaining unpurchased items. We assume the training data to contain n market baskets with m items.

In more detail, the first step 202 is to collect statistics from the training data. This involves the following:

(a) For each item j, obtain nⱼ the number of baskets with item j purchased.

(b) For each item j, obtain nⱼ′ the number of baskets with j being the sole item purchased.

(c) For each pair of items i and j, obtain the number of market baskets nⱼᵢwith items j and i purchased together.

(d) For each pair of items i and j, obtain the number of market baskets nⱼᵢ′ with items i and j being the only two items purchased.

The second step 203 is to precompute model parameters. This involves the following:

(a)

$$Compute P ( renewal ) = \frac{{\sum }_{k} {n}_{k}^{′}}{{\sum }_{k} {n}_{k}} . \qquad ( equation ( 10 ) )$$

(b)

$$For each item j , compute P ( j ) = \frac{{n}_{j}}{{\sum {n}_{k}}_{k}} , or use equation ( 9 B ) ) . \qquad \text{(equation (9A)}$$

(c)

$$For each item j , compute P ( renewal \vert j ) = \frac{{n}_{j}^{′}}{{n}_{j}} + P ( renewal ) ( 1 - \frac{{n}_{j}^{′}}{{n}_{j}} ) . \qquad ( equation ( 11 ) )$$

(d)

$$For each item j , compute {P}^{′} ( j \vert renewal ) = P ( renewal \vert j ) \times \frac{P ( j )}{P ( renewal )} . \qquad ( equation ( 3 ) )$$

(e)

$$For each pair of items i and j with {n}_{ij} \neq 0 , compute P ( j \vert i ) = \frac{{n}_{ji}}{{\sum }_{k} {n}_{ki}} . \qquad ( equation ( 12 ) )$$

(f)

$$For each pair of items i and j with {n}_{ij} \neq 0 , compute P ( renewal \vert j , i ) = \frac{{n}_{ji}^{′}}{{n}_{ji}} + P ( renewal ) ( 1 - \frac{{n}_{ji}^{′}}{{n}_{ji}} ) . \qquad ( equation ( 13 ) )$$

(g)

$$For each pair of items i and j with {n}_{ij} \neq 0 , compute {P}^{′} ( j \vert asso , i ) = P ( j \vert i ) \times \frac{( 1 - P ( renewal \vert j , i ) )}{( 1 - P ( renewal \vert i ) )} . \qquad ( equation ( 7 ) )$$

The third step is to calculate a recommended ordering for a given partial market basket. Given a partial basket B={i₁, i₂, . . . , iₖ}, let \overline{B} be the complementary set of items not in B. Then

(a) If B is empty, the sort items in order of decreasing P(j|renewal) and return this as the item preference ordering.

(b) If B is non-empty, then

(i) Compute P(renewal|B)=minᵢ_{ₖ}_{εB}P(renewal|iₖ) (equation (4)).

(ii) Compute the normalization factor

$${\sum }_{k ∈ \overline{B}} {P}^{′} ( k \vert renewal ) .$$

(iii) For each item jε\overline{B}, compute

$$P ( j \vert renewal ) = \frac{{P}^{′} ( j \vert renewal )}{{\sum }_{k ∈ \overline{B}} {P}^{′} ( k \vert renewal )} .$$

(iv) Compute the normalization factor

$${\sum }_{j ∈ \overline{B}} {P}^{′} ( j \vert asso , B ) .$$

(v) For each item jε\overline{B}, compute

P′(j|asso,B)=maxᵢ_{ₖ}_{εB}P(j|asso,iₖ) (equation(5))

(vi) For each item jε\overline{B}, compute

$$P ( j \vert asso , B ) = \frac{{P}^{′} ( j \vert asso , B )}{{\sum }_{k ∈ \overline{B}} {P}^{′} ( k \vert asso , B )} . \qquad ( equation ( 6 ) )$$

(vii) For each item jε\overline{B}, compute

P(j|B)=P(j|asso,B)P(asso|B)+P(j|renewal,B)P(renewal|B) (equation (1)).

(viii) Sort items in order of decreasing P(j|B) and return this as the item preference ordering.

One skilled in the art can utilize many techniques to reduce the storage requirement to process the present invention when the number of items is very large: reduced accuracy for probabilities, sparce matrix storing techniques, and clustering of like items to reduce the number of items, which can be later refined for the cluster members after the cluster preferences are computed.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for making prioritized recommendations to a customer in the process of filling a market basket for purchase on an Internet commerce site, the method comprising the steps of:
generating a matrix of training data;
considering preferences based on associative and renewal buying history from the training data; and
making a prioritized recommendation of items so as to maximize the likelihood that the customer will add to the market basket those items with higher priorities.

2. The method of claim 1, wherein the two preferences are estimated separately from the training data and combined in proper proportions to obtain an overall preference for item not yet in the market basket.

3. A method for making prioritized recommendations to a customer in the process of filling a market basket for purchase on an Internet commerce site, the method comprising the steps of:
collecting statistics from training data;
precomputing model parameters from the collected statistics; and
recommending ordering for a given partial market basket based on the precomputed model parameters.

4. The method of claim 3, wherein the step of collecting statistics comprises the steps of:
(a) for each item j, obtaining nⱼ a number of baskets with item j purchased;
(b) for each item j, obtaining nⱼ′ a number of baskets with j being a sole item purchased;
(c) for each pair of items i and j, obtaining a number of market baskets nⱼᵢ with items j and i purchased together; and
(d) for each pair of items i and j, obtaining a number of market baskets nⱼᵢ′ with items i and j being the only two items purchased.

5. The method of claim 4, wherein the step of precomputing model parameters comprises the steps of:
$$( a ) computing P ( renewal ) = \frac{{\sum }_{k} {n}_{k}^{′}}{{\sum }_{k} {n}_{k}} ;$$
$$( b ) for each item j , computing P ( j ) = \frac{{n}_{j}}{{\sum }_{k} {n}_{k}} ;$$
(c) for each item j,
$$computing P ( renewal \vert j ) = \frac{{n}_{j}^{′}}{{n}_{j}} + P ( renewal ) ( 1 - \frac{{n}_{j}^{′}}{{n}_{j}} ) ;$$
(d) for each item j, computing
$${P}^{′} ( j \vert renewal ) = P ( renewal \vert j ) \times \frac{P ( j )}{P ( renewal )} ;$$
(e) for each pair of items i and j with nᵢⱼ≠0, computing
$$P ( j \vert i ) = \frac{{n}_{j i}}{{\sum }_{k} {n}_{k i}} ;$$
(f) for each pair of items i and j with nᵢⱼ≠0, computing
$$P ( renewal \vert j , i ) = \frac{{n}_{j i}^{′}}{{n}_{j i}} + P ( renewal ) ( 1 - \frac{{n}_{j i}^{′}}{{n}_{j i}} ) ; and$$
(g) for each pair of items \overline{i} and j with nᵢⱼ≠0, computing
$${P}^{′} ( j \vert a s s o , i ) = P ( j \vert i ) \times \frac{( 1 - P ( renewal \vert j , i ) )}{( 1 - P ( renewal \vert i ) )} .$$

6. The method of claim 5, wherein given a partial basket B−{i₁, i₂, . . . , iₖ} and \overline{B} is a complementary set of items not in B, the step of recommending ordering for a given partial market basket comprises the steps of:
(a) if B is empty, sorting items in order of decreasing P(j|renewal) and returning this as an item preference ordering;
(b) if B is non-empty, then
(i) computing P(renewal|B)=minᵢ_{ₖ}_{εB}P(renewal|iₖ);
(ii) compute a normalization factor
$${\sum }_{k ∈ \overline{B}} {P}^{′} ( k \vert renewal ) ;$$
(iii) for each item jε\overline{B}, computing
$$P ( j \vert renewal ) = \frac{{P}^{′} ( j \vert renewal )}{{\sum }_{k ∈ \overline{B}} {P}^{′} ( k \vert renewal )} ;$$
(iv) computing a normalization factor
$${\sum }_{k ∈ \overline{B}} {P}^{′} ( j \vert a s s o , B ) ;$$
(v) for each item jε\overline{B}, computing
P′(j|asso,B)=maxᵢ_{ₖ}_{εB}P(j|asso,iₖ);
(vi) for each item jε\overline{B}, computing
$$P ( j \vert a s s o , B ) = \frac{{P}^{′} ( j \vert a s s o , B )}{{\sum }_{k ∈ \overline{B}} {P}^{′} ( k \vert a s s o , B )} ;$$
(vii) for each item jε\overline{B}, computing
P(j|B)=P(j|asso,B)P(asso|B)+P(renewal|B);
and
(viii) sorting items in order of decreasing P(j|B) and returning this as an item preference ordering.

7. The method of claim 6, wherein the step of sorting comprises the step of using a final probability obtained for each item, P(j|B), of a customer buying the item to maximize profit by recommendation.

8. The method of claim 7, wherein the step of using a final probability of an item to maximize profit comprises the steps of:
assigning a profit amount, $ⱼ, to each item;
computing P(j|B)$ⱼ for each item; and
ranking recommendations based on the computation of P(j|B)$ⱼ for each item.
